(19) United States
(12) Patent Application Publication
(10) Pub. No.: US 2011/0313116 A1
(43) Pub. Date: Dec. 22, 2011

(54) Polymerization Process Utilizing Hydrogen

(75) Inventor: David Knoeppel, League City, TX (US)

(73) Assignee: Fina Technology, Inc., Houston, TX (US)

(21) Appl. No.: 12/817,269

(22) Filed: Jun. 17, 2010

(51) Int. Cl. C08F 4/24

(52) U.S. Cl. 526/106

(57) ABSTRACT

Ethylene polymerization processes and polymers formed from the same are discussed herein. The ethylene polymerization processes generally include introducing ethylene monomer into a polymerization reaction zone; introducing a chromium oxide based catalyst into the polymerization reaction zone; introducing a quantity of hydrogen into the polymerization reaction zone; and contacting the ethylene monomer with the chromium oxide based catalyst in the polymerization reaction zone in the presence of hydrogen to form polyethylene, wherein the polyethylene formed in the presence of hydrogen exhibits an MI₂ that increases with an increasing quantity of hydrogen and a molecular weight and molecular weight distribution that remains essentially constant with an increasing quantity of hydrogen.

### FIELD

Embodiments of the present invention generally relate to polymerization processes. Particularly, embodiments relate to polymerization processes utilizing chromium oxide catalysts in the presence of hydrogen.

### BACKGROUND

As reflected in the patent literature, hydrogen may be utilized in polymerization reactions for a variety of purposes, such as altering molecular weight or melt index of the resultant polymers. However, polymerization reactions utilizing chromium oxide based catalysts generally are not affected by hydrogen addition.

Therefore, a need exists to develop a polymerization process capable of alteration of polymer properties, such as melt index, during polymerization.

### SUMMARY

Embodiments of the present invention include ethylene polymerization processes. The ethylene polymerization processes generally include introducing ethylene monomer into a polymerization reaction zone; introducing a chromium oxide based catalyst into the polymerization reaction zone; introducing a quantity of hydrogen into the polymerization reaction zone; and contacting the ethylene monomer with the chromium oxide based catalyst in the polymerization reaction zone in the presence of hydrogen to form polyethylene, wherein the polyethylene formed in the presence of hydrogen exhibits an MI₂ that increases with an increasing quantity of hydrogen and a molecular weight and molecular weight distribution that remains essentially constant with an increasing quantity of hydrogen.

One or more embodiments include the process of the preceding paragraph, wherein the polyethylene exhibits a shear response that is narrower than a shear response of the ethylene based polymer in the absence of hydrogen.

One or more embodiments include the process of any preceding paragraph, wherein the polyethylene formed in the presence of hydrogen exhibits an SR₂ that decreases with an increasing quantity of hydrogen.

One or more embodiments include polyethylene formed by the process of any preceding paragraph.

One or more embodiments include a polyethylene homopolymer formed by the process of any preceding paragraph.

One or more embodiments include the process of any preceding paragraph, wherein the chromium oxide based catalyst includes from about 0.5 wt. % to about 4 wt. % titanium.

One or more embodiments include the process of any preceding paragraph, wherein the chromium oxide based catalyst includes from about 0.5 wt. % to about 5 wt. % chromium.

One or more embodiments include the process of any preceding paragraph, wherein the chromium oxide based catalyst is activated at temperature of from about 1000° F. to about 1600° F.

One or more embodiments include the process of any preceding paragraph, wherein the chromium oxide based catalyst is activated at temperature of from about 1250° F. to about 1350° F.

### BRIEF DESCRIPTION OF DRAWINGS

FIG. 1 illustrates hydrogen effects on activity.

FIG. 2 illustrates MI₂ versus hydrogen charge.

FIG. 3 illustrates MI₅ versus hydrogen charge.

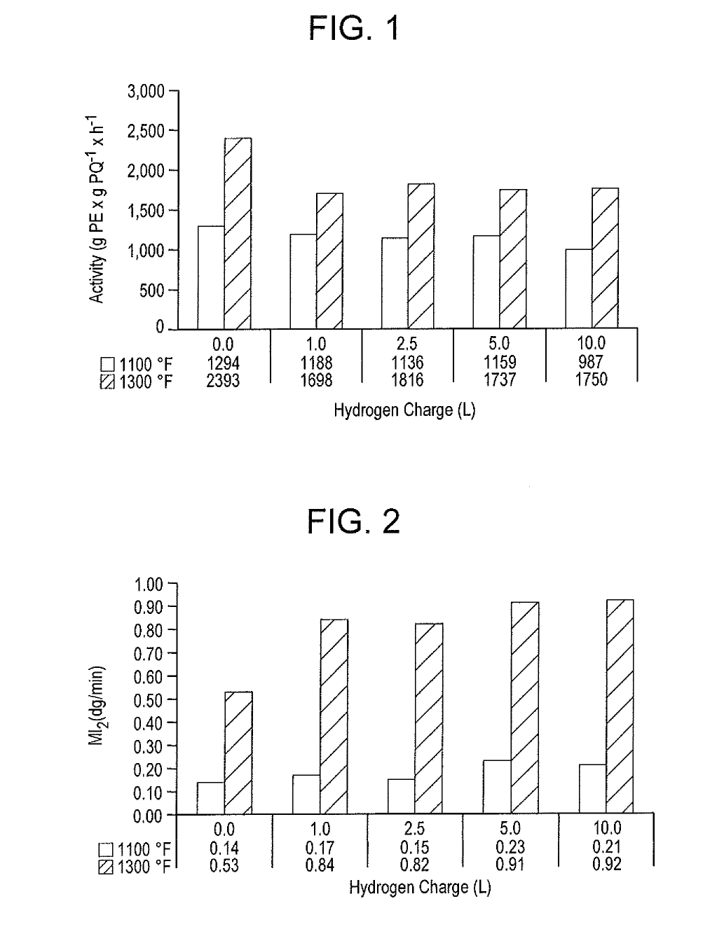

FIG. 1 illustrates HLMI versus hydrogen charge.

FIG. 2 illustrates GPC traces for 1100° F. activated catalyst.

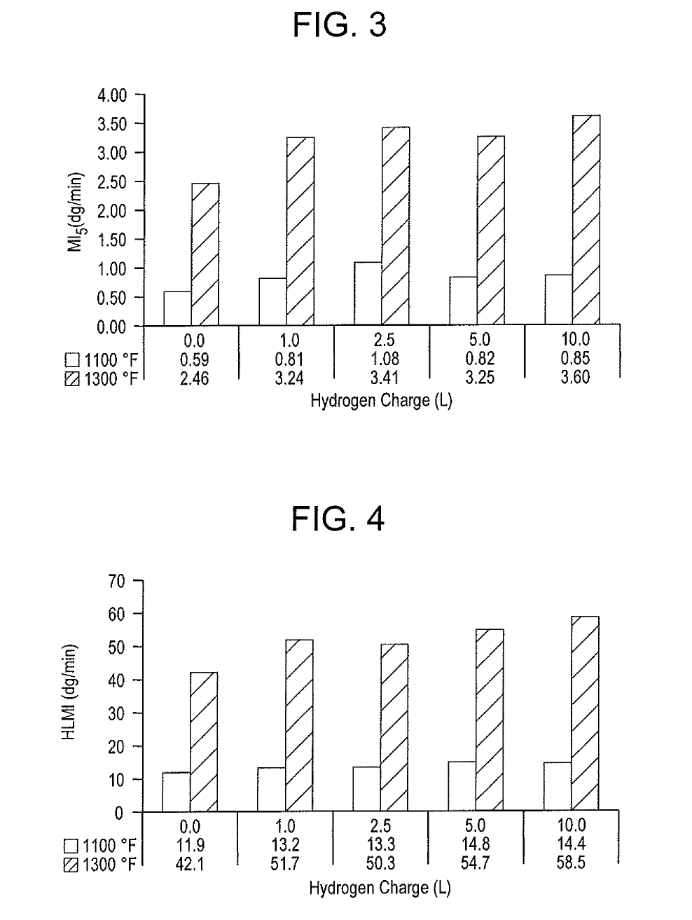

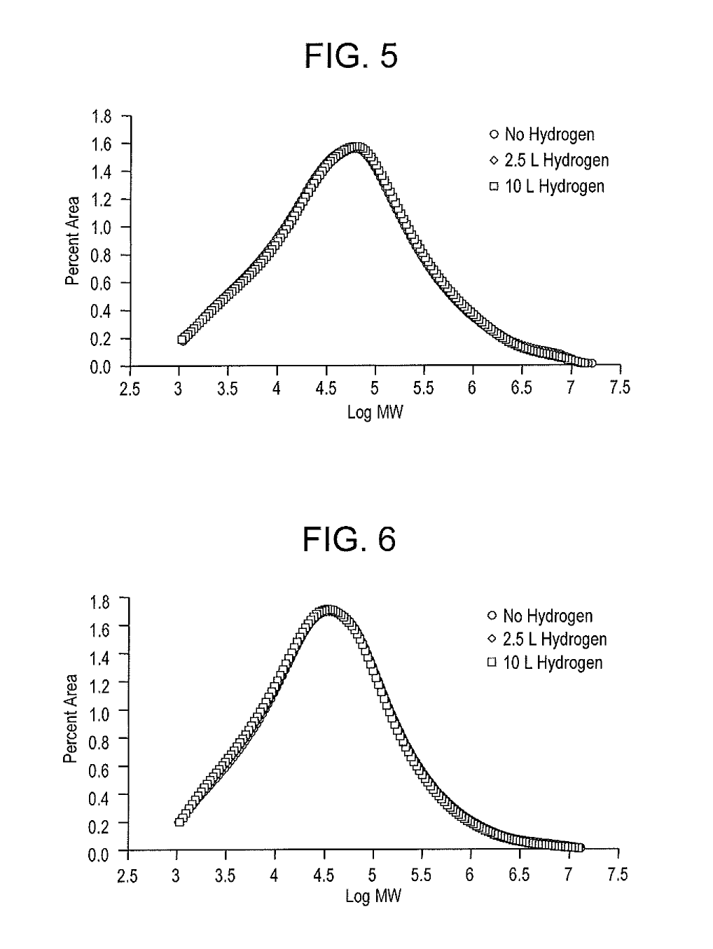

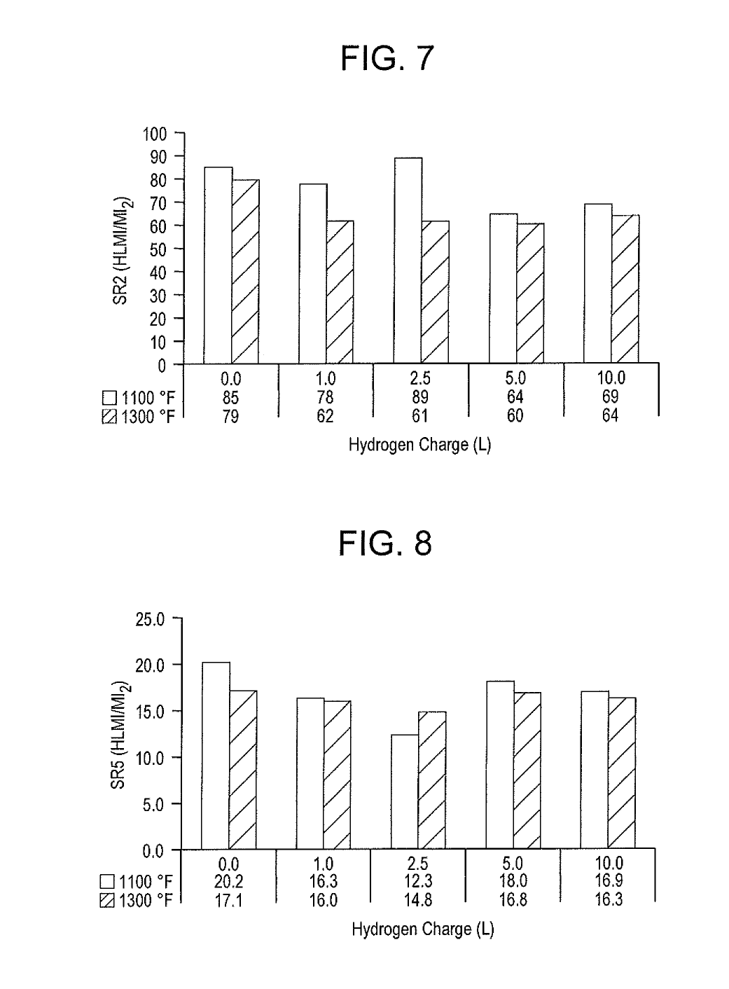

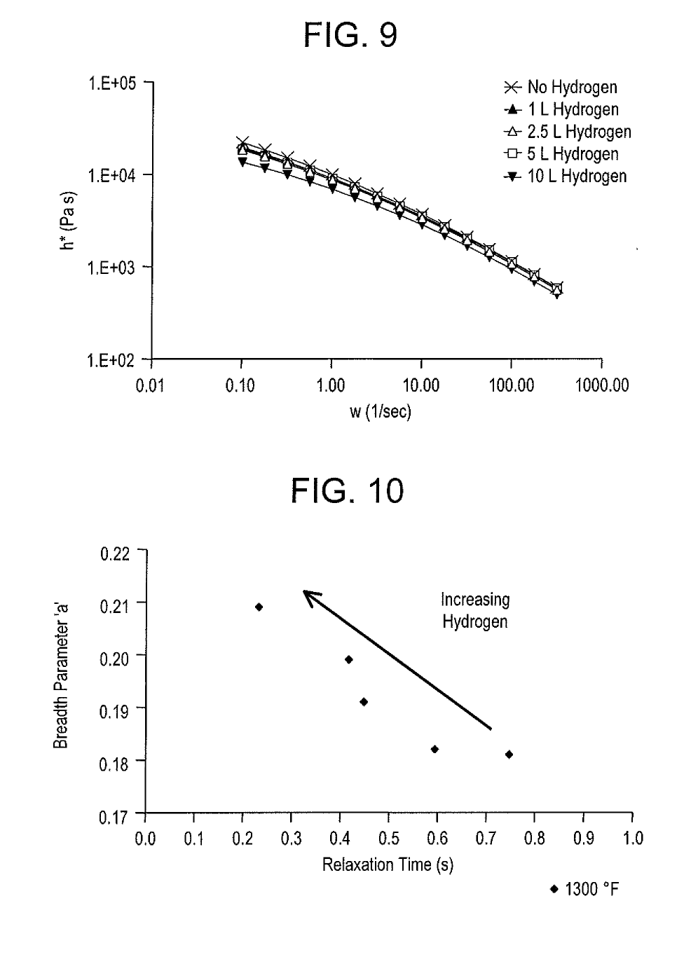

FIG. 3 illustrates GPC traces for 1300° F. activated catalyst.

FIG. 4 illustrates SR2 versus hydrogen charge.

FIG. 5 illustrates SR5 versus hydrogen charge.

FIG. 6 illustrates 1300° F. catalyst activation flow curves.

FIG. 7 illustrates 1300° F. catalyst activation breadth versus relaxation time.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

### Catalyst Systems

Catalyst systems useful for polymerizing olefin monomers include suitable catalyst systems. For example, the catalyst system may include chromium oxide based catalyst systems. The catalysts may be activated for subsequent polymerization and may or may not be associated with a support material, for example. A brief discussion of such catalyst systems is included below, but is in no way intended to limit the scope of the invention to such catalysts.

In one or more embodiments, the catalyst system generally includes a chromium oxide based catalyst. The chromium oxide based catalysts include those known by ones skilled in the art, such as those described in U.S. Pat. No. 2,825,721; U.S. Pat. No. 3,087,917; and U.S. Pat. No. 3,622,521, which are incorporated by reference herein.

In one or more embodiments, the chromium oxide based catalyst may include from about 0.5 wt. % to about 5 wt. % or from about 1 wt. % to about 3 wt. % chromium, for example.

In one or more embodiments, the chromium oxide based catalyst may have a particle size of from about 50 microns to about 500 microns or from about 75 microns to about 150 microns, for example.

In one or more embodiments, the chromium oxide based catalyst further includes titanium. The chromium oxide based catalyst may include from about 0.5 wt. % to about 4 wt. % or from about 1.5 wt. % to about 3.0 wt. % titanium, for example.

In one or more embodiments, the chromium oxide based catalyst may have a surface area of from about 200 m²/g to about 750 m²/g or from about 400 m²/g to about 600 m²/g, for example.

In one or more embodiments, the chromium oxide based catalyst may have a pore volume of from about 1.0 cc/g to about 5.0 cc/g or from about 2.0 cc/g to about 3.0 cc/g, for example.

In one or more embodiments, the chromium oxide based catalyst may include a titanated chrome catalyst available from PQ Corporation.

The catalyst may be activated by exposure to heat. In one or more embodiments, the chromium oxide based catalyst is activated at temperature of from about 1000° F. to about 1600° F., or from about 1000° F. to about 1150° F. or from about 1250° F. to about 1350° F., for example.

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, 4-methyl-1-pentene, hexene, octene and decene), for example. The monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, norbornadiene, isobutylene, isoprene, vinylbenzycyclobutane, styrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. The loop reactor may be maintained at a pressure of from about 27 bar to about 50 bar or from about 35 bar to about 45 bar and a temperature of from about 38° C. to about 121° C., for example. Reaction heat may be removed through the loop wall via any suitable method, such as via a double jacketed pipe or heat exchanger, for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example.

One or more embodiments include introducing hydrogen to the polymerization process. Generally, chromium oxide based catalysts do not experience a significant response to hydrogen. In contrast to processes utilizing Ziegler-Natta or metallocene catalysts, introduction of hydrogen into processes utilizing chromium oxide based catalysts do not generally result in a significant change in resultant polymer properties. However, embodiments of the invention unexpectedly result in an unexpected hydrogen response. For example, the polymers formed via the embodiments described herein generally result in an increasing melt index with an increasing quantity of hydrogen introduced into the reaction process.

Furthermore, embodiments of the invention are capable of forming polymers exhibiting a shear response that is narrower than a shear response of an identical polymer formed in the absence of hydrogen.

Generally, melt index and molecular weight are inversely related. Accordingly, if melt index changes, the polymer molecular weight will be altered accordingly. However, embodiments of the invention generally result in a polymer capable of an increasing melt index with an increase in hydrogen without a resultant decreased molecular weight.

### Polymer Product

The polymers (and blends thereof) formed via the processes described herein may include, but are not limited to, linear low density polyethylene, elastomers, plastomers, high density polyethylenes, low density polyethylenes, medium density polyethylenes, polypropylene and polypropylene copolymers, for example.

Unless otherwise designated herein, all testing methods are the current methods at the time of filing.

In one or more embodiments, the polymers include ethylene based polymers. As used herein, the term “ethylene based” is used interchangeably with the terms “ethylene polymer” or “polyethylene” and refers to a polymer having at least about 50 wt. %, or at least about 70 wt. %, or at least about 75 wt. %, or at least about 80 wt. %, or at least about 85 wt. % or at least about 90 wt. % polyethylene relative to the total weight of polymer, for example.

The ethylene based polymers may have a density (as measured by ASTM D-792) of from about 0.86 Wee to about 0.98 g/cc, or from about 0.88 g/cc to about 0.965 g/cc, or from about 0.90 g/cc to about 0.965 g/cc or from about 0.925 g/cc to about 0.97 g/cc, for example.

The ethylene based polymers may have a melt index (MI₂) (as measured by ASTM D-1238) of from about 0.01 dg/min to about 100 dg/min., or from about 0.01 dg/min. to about 25 dg/min., or from about 0.03 dg/min. to about 15 dg/min. or from about 0.05 dg/min. to about 10 dg/min, for example.

The ethylene based polymers may exhibit a shear response (SR₂) (as measured by) of from about 50 to about 100, or from about 55 to about 90 or from about 60 to about 85, for example.

In one or more embodiments, the polymers include low density polyethylene. As used herein, the term “low density polyethylene” refers to ethylene based polymers having a density of less than about 0.92 g/cc, for example. In one or more embodiments, the polymers include linear low density polyethylene.

In one or more embodiments, the polymers include medium density polyethylene. As used herein, the term “medium density polyethylene” refers to ethylene based polymers having a density of from about 0.92 g/cc to about 0.94 g/cc or from about 0.926 g/cc to about 0.94 g/cc, for example.

In one or more embodiments, the polymers include high density polyethylene. As used herein, the term “high density polyethylene” refers to ethylene based polymers having a density of from about 0.94 g/cc to about 0.97 g/cc, for example.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheets, such as thermoformed sheets (including profiles and plastic corrugated cardboard), geomembranes and pond liners, for example. Molded articles include single and multi-layered constructions in the form of bottles, tanks, large hollow articles, rigid food containers and toys, for example.

### EXAMPLES

A chromium oxide based catalyst (PQ C25305, commercially available from PQ Corporation) was activated at 1100 and 1300° F. and screened under homopolymer conditions in a bench reactor under the conditions specified in Table 1. A single hydrogen charge was added to the bench reactor prior to catalyst addition.

TABLE 1

| Diluent | Isobutane |
|---|---|
| Reactor Temperature (° C.) | 104 |
| C25305 Charge (mg) | 350 |
| Productivity Target (g PE/g Cat) | 1000 |
| Ethylene Concentration (Wt. %) | 8 |
| 1-Hexene Concentration (Wt. %) | 0 |
| Hydrogen Charge (L) | 0, 1, 2.5, 5, 10 |

Activity data are shown in FIG. 1. A slight drop in activity is observed with the additions of hydrogen. While it appears that a larger change is seen for the 1300° F. catalyst, typical activities are in the range of 1,900 g PE/g catalyst. Interestingly, it does not appear that activity is affected by the quantity of hydrogen once introduced to the reactor.

Melt flow trends with respect to the hydrogen concentration are shown in FIG. 2 through FIG. 4. Whether activated at 1100 or 1300° F., a boost in MI is observed with the addition of hydrogen. While not as responsive as a metallocene or Ziegler-Natta catalyst, it does appear that melt flows trend with hydrogen concentration.

GPC traces for selected 1100 and 1300° F. polymers are shown in FIG. 5 and FIG. 6, respectively. The data imply that no significant changes in the molecular weight or molecular weight distribution are observed with hydrogen addition.

While not reflected in the MW data, the shear response numbers given in FIG. 7 and FIG. 8 indicate that hydrogen leads to rheologically narrower polymers. The flow curves and CY data for the 1300° F. polymers agree with the shear response numbers (FIG. 9 and FIG. 10). The consistent MWD and drastically changing shear thinning behavior implies that the formation of long chain branches is hindered with hydrogen.

While the foregoing is directed to embodiments of the present invention, other and further embodiments of the invention may be devised without departing from the basic scope thereof and the scope thereof is determined by the claims that follow.

What is claimed is:

1. An ethylene polymerization process comprising:
introducing ethylene monomer into a polymerization reaction zone;
introducing a chromium oxide based catalyst into the polymerization reaction zone;
introducing a quantity of hydrogen into the polymerization reaction zone; and
contacting the ethylene monomer with the chromium oxide based catalyst in the polymerization reaction zone in the presence of hydrogen to form polyethylene, wherein the polyethylene formed in the presence of hydrogen exhibits an MI₂ that increases with an increasing quantity of hydrogen and a molecular weight and molecular weight distribution that remains essentially constant with an increasing quantity of hydrogen.

2. The process of claim 1, wherein the polyethylene exhibits a shear response that is narrower than a shear response of the ethylene based polymer in the absence of hydrogen.

3. The process of claim 1, wherein the polyethylene formed in the presence of hydrogen exhibits an SR₂ that decreases with an increasing quantity of hydrogen.

4. Polyethylene formed by the process of claim 1.

5. The polyethylene of claim 4, wherein the polyethylene is a polyethylene homopolymer.

6. The process of claim 1, wherein the chromium oxide based catalyst comprises from about 0.5 wt. % to about 4 wt. % titanium.

7. The process of claim 1, wherein the chromium oxide based catalyst comprises from about 0.5 wt. % to about 5 wt. % chromium.

8. The process of claim 1, wherein the chromium oxide based catalyst is activated at temperature of from about 1000° F. to about 1600° F.

9. The process of claim 1, wherein the chromium oxide based catalyst is activated at temperature of from about 1250° F. to about 1350° F.

10. An ethylene polymerization process comprising:
introducing ethylene monomer into a polymerization reaction zone;
introducing a chromium oxide based catalyst into the polymerization reaction zone, wherein the chromium oxide based catalyst comprises from about 0.5 wt. % to about 4 wt. % titanium and from about 0.5 wt. % to about 5 wt. % chromium;
introducing a quantity of hydrogen into the polymerization reaction zone; and
contacting the ethylene monomer with the chromium oxide based catalyst in the polymerization reaction zone in the presence of hydrogen to form polyethylene, wherein the polyethylene formed in the presence of hydrogen exhibits an MI₂ that increases with an increasing quantity of hydrogen and a molecular weight and molecular weight distribution that remains essentially constant with an increasing quantity of hydrogen.

11. The process of claim 10, wherein the polyethylene exhibits a shear response that is narrower than a shear response of the ethylene based polymer in the absence of hydrogen.

12. The process of claim 10, wherein the polyethylene formed in the presence of hydrogen exhibits an SR₂ that decreases with an increasing quantity of hydrogen.

13. Polyethylene formed by the process of claim 10.
